(19) United States
(12) Patent Application Publication
(10) Pub. No.: US 2004/0089024 A1
(43) Pub. Date: May 13, 2004

(54) Preparation of high purity, low water content fused silica glass

(75) Inventors: Minoru Tomozawa, Troy, NY (US); Victor Lou, Schenectady, NY (US)

Correspondence Address: HESLIN ROTHENBERG FARLEY & MESITI PC, 5 COLUMBIA CIRCLE, ALBANY, NY, 12203, US

(73) Assignee: Rensselaer Polytechnic Institute, Troy, NY (US)

(21) Appl. No.: 10/290,999

(22) Filed: Nov. 8, 2002

(51) Int. Cl. C03B 32/00; C03B 32/02

(52) U.S. Cl. 65/33.1

(57) ABSTRACT

A process for the preparation of crystalline silica powder from amorphous silica powder is disclosed. The water and hydroxyl content in the crystalline powder is much lower than that in the amorphous silica powder. The process involves heating the amorphous silica powder in the presence of a noble metal without the need for adding an impurity, such as an alkali crystallization promoter. Preferably, the amorphous silica powder is sol-gel derived, and a high purity silica glass product can therefore be made having a water content of less than 0.1 ppm.

The following invention was made with Government support under contract number DE-FG-36-01-GO11013 awarded by the United States Department of Energy. The Government has certain rights in this invention.

### FIELD OF THE INVENTION

The invention relates to a process for the preparation of crystalline silica powder and fused silica glass having a very low water content, and also to such glasses being of high purity.

### BACKGROUND OF THE INVENTION

High purity silica glasses are widely used in both the electronics industry and in optical communications. Impurities are often sources of poor electrical, optical and mechanical characteristics, as well as the origins of the premature degradation of thermal, chemical and mechanical characteristics. Often, conventional silica glasses contain impurities such as Al₂0₃, Ti0₂, alkalis, oxides, water (including hydroxyl, —OH⁻) and chlorine. These impurities are either impurities in the raw materials (e.g., Al₂0₃, TiO₂) in the case of fused silica or added deliberately to eliminate more detrimental impurities (e.g., Cl⁻ addition to remove hydroxyl) in the case of SiCl₄-derived silica glass. In many cases, it is desirable to have no impurities in silica glasses to achieve the highest quality.

Sol-gel processing can yield high purity amorphous powder, which can be used as a raw material for glass melting. The process is explained in detail by S. Sakka, “Gel Method for Making Glass”, Treatise on Materials Science and Technology 22, 129-67 (M. Tomozawa and R. H. Doremus eds., 1982) and by C. J. Brinker and G. W. Scherer, Sol-Gel Science (1990). In general, silica powder made by this process has a much lower concentration of impurities compared with natural quartz powder commonly used for silica glass melting. Furthermore, the silica glass prepared by melting the sol-gel-derived silica powder exhibits neither optical absorption at ˜240 nm nor corresponding photo luminescence, which are due to oxygen vacancy. The sol-gel-derived silica glasses are clearly purer and have superior optical properties.

However, one difficulty of the sol-gel process is the high water (hydroxyl) concentration remaining in the glass products. Even when the glass melting is conducted under vacuum, K. Shima and A. Utsunomiya reported in Ceramics 33, 39 (1998), that the hydroxyl concentration remaining in the glass ranges from 5 to 30 ppm. By contrast, as reported by R. Bruckner in J. Non-Crystalline Solids 5, 123-75 (1970), melting of crystalline silica powder, e.g., quartz powder, using a similar process produces a silica glass having a hydroxyl concentration of 5 ppm or less.

Water has detrimental effects on many properties of glasses, including silica glasses. For example, it is well-known that water increases the optical transmission loss. Additionally, water causes the quenching of the laser effect of rare-earth elements in glasses and decreases their photo luminescence lifetime. These effects impair the characteristics of optical fiber amplifiers, for example. Furthermore, water causes deterioration of thermal, chemical, and mechanical properties. Recently, A. Ikari et al. reported in Jpn. J. Appl. Phys. 35, 3547 (1996) that the density of brownish rings formed at the interface of a silica glass crucible and silicon melt increases drastically with increasing water content in silica glass. For all these reasons, it is desirable to minimize the hydroxyl concentration in high quality silica glass products.

J. Phalippou et al. reported in J. Non-Cryst. Solids 48, 17 (1982) that amorphous silica, including that made by the sol-gel process, can be transformed into a crystalline phase, usually cristobalite, by an appropriate heat-treatment and by adding a small quantity of alkali. Taking advantage of this process, and knowing that water removal is easier from crystalline silica powder, Seki et al. successfully produced silica glasses with low hydroxyl concentration by melting crystallized silica powders, which were prepared by heat-treating amorphous silica powders intentionally mixed with a small amount of a crystallization-promoting agent such as alkali (Japanese Patent No. 1864078 issued 1993). One drawback to the process, however, is that the complete removal of the added alkali from the silica glass product is difficult.

It is therefore desirable to produce crystalline silica powder from amorphous silica powder, preferably derived from a sol-gel process, without introducing impurities. Such crystalline powders are useful as raw materials for high purity, low water content, silica glass.

### SUMMARY OF THE INVENTION

The present invention is based on the unexpected discovery that crystalline silica powder can be produced from amorphous silica powder without the addition of alkalis or other impurities which are difficult to remove. Therefore, the invention avoids the problems associated with prior crystallization methods. In addition, because the silica powder produced by the present process is crystalline, the water content in the final product silica glass is very low, i.e., less than 0.1 ppm. Also, when amorphous silica powder derived from a sol-gel process is used in the process, the resulting silica glass is of very high purity.

Accordingly, in one aspect, the present invention relates to a process for the preparation of a crystalline silica powder from an amorphous silica powder. The process is advantageous because no impurities, such as alkalis or chlorine, are introduced to promote crystallization or to remove other impurities. The process comprises:

(a) providing an amorphous silica powder;

(b) heating the amorphous silica powder in the presence of a noble metal at a temperature ranging from about 1300° C. to about 1700° C., but preferably from about 1350° C. to about 1400° C., for a time sufficient to form the crystalline silica powder. Furthermore, in the processes presented herein, it is preferable that the amorphous silica powder be derived from a sol-gel process. The water content in the resulting crystalline silica powder is significantly lower than that in the untreated amorphous silica powder.

As used herein, the term “noble metal” includes silver, gold, and platinum, as well as alloys thereof Platinum and gold are preferred, and platinum is particularly preferred. In addition, an “amorphous” powder contains noncrystalline particles in the solid state having no molecular lattice structure. A “crystalline” powder contains particles having a definite lattice pattern and having characteristic shapes and cleavage planes due to the arrangement of their molecules. Use of the term “impurity” refers to the presence of one substance (foreign substance) in another. “High purity” means substantially pure, or having an impurity content of less than 0.01 wt. %. As used herein, the term “wt. %” means percentage by weight based on the total weight of the material.

In another aspect, the invention relates to a process comprising:

(a) providing a first portion of an amorphous silica powder, preferably sol-gel-derived;

(b) heating the first portion of the amorphous silica powder in the presence of a noble metal at a temperature ranging from about 1300° C. to about 1700° C. for a time sufficient to form a crystallized powder;

(c) mixing the crystallized powder with a second portion of the amorphous silica powder to form a mixture;

(d) heating the mixture at a temperature ranging from about 1300° C. to about 1700° C. for a time sufficient to form a crystalline silica powder. The preferable heating temperatures are as provided above. Advantageously, the crystallization occurs in the absence of alkali to promote crystallization.

In yet another aspect, the invention is directed to a process for preparing silica glass. The process comprises:

(a) providing a crystalline silica powder prepared by crystallizing amorphous silica powder, preferably sol-gel derived, in the presence of a noble metal;

(b) melting the crystalline silica powder to form a molten glass; and

(c) cooling the molten glass to form the silica glass.

In yet another aspect, the invention relates to high purity silica glass having a water content of less than 0.1 ppm.

### BRIEF DESCRIPTION OF THE DRAWINGS

FIG. 1 is a plot of intensity vs. diffraction angle, 2Θ, which shows the X-ray diffraction pattern of silica powders before and after the process of the present invention.

FIG. 2 is an IR absorbance spectrum of SiO₂ powders (absorbance vs. wavenumber).

FIG. 3 an IR absorbance spectrum of SiO₂ glass samples (absorbance vs. wavenumber).

### DESCRIPTION OF THE PREFERRED EMBODIMENTS

The present invention relates to a process for the preparation of low water content crystalline silica powder, which can then be used to fabricate high purity, fused silica glass having a water content less than 0.1 ppm and being free of added impurities. By contrast, the water content of glass made in the same way from amorphous silica powders is much higher, up to about 44 ppm.

In the process of the present invention, amorphous silica powder, preferably prepared by a sol-gel process, is provided as the starting material. Sol-gel-derived amorphous powders for use in the present invention, can be obtained commercially from Mitsubishi Chemical Company, or be prepared by the processes described in the references previously cited herein (i.e. S. Sakka, “Gel Method for Making Glass”, Treatise on Materials Science and Technology 22, 129-67 (M. Tomozawa and R. H. Doremus eds., 1982); C. J. Brinker and G. W. Scherer, Sol-Gel Science (1990)).

To promote surface crystallization, the amorphous silica powder is heated in the presence of a noble metal, as previously defined. Preferably, the noble metal will be platinum or gold, but most preferably platinum. Temperatures ranging from about 1300° C. to about 1700° C. may be used in the crystal nucleation process. Temperatures ranging from about 1350° C. to about 1400° C. are preferred. As one of ordinary skill would know, crystallization times will vary with the heating temperature. For example, when the temperature is as high as 1700° C., a time of only about 5 hours will be needed for crystallization to occur. Much longer times are necessary when a lower temperature is used, such as about 24 hours at 1350° C.

Although the process of crystallization of pure silica is slow, once a small quantity of crystallized silica powder is obtained, this small quantity can then be used to crystallize additional amorphous powder. For example, after crystallization of a first portion of amorphous powder has begun, the crystallized powder can be mixed with fresh (a second portion of) amorphous silica powder, and reheated to a temperature in the range previously provided without the inclusion of the noble metal. Typically, a mixture containing from about 5-25 wt. %, but preferably about 15 wt. %, crystallized powder is suitable. The heat treatment can be repeated as many times as necessary until crystallization is complete or has reached an acceptable level.

Silica glasses may then be prepared by conventionally melting the crystalline silica powder to form a molten glass. Typically, a temperature ranging from about 1750° C. to about 2000° C., but preferably about 1800° C., is suitable. Those of ordinary skill will be able to determine without undue experimentation the length of time and the temperature needed to provide the molten silica glass. Upon cooling, fused silica glass is formed.

One of the advantages of the present process is that high purity (substantially pure), low water content (<0.1 ppm) silica glasses can be prepared, particularly when the starting material is sol-gel-derived amorphous silica powder. However, as one of skill would know, the purity of the glass will depend on the origin of the starting amorphous silica powder. Furthermore, no impurities (such as alkali) are added to the powders using the present process, which assists in improving the purity of the products. High purity, low water content silica glasses are especially desirable for use in the fabrication of devices used in electronics and optical communications.

The following examples are for illustrative purposes, and one of ordinary skill in the art would understand that other times and temperatures may be used to prepare crystalline silica powder and silica glasses. The present invention is not limited to the specific embodiments found in the examples.

### EXAMPLES

Unless otherwise indicated, the reactants and reagents used in the reactions described below are readily available materials. Such materials can be conventionally prepared in accordance with conventional preparatory procedures or obtained from commercial sources.

The sol-gel-derived amorphous silica powder obtained from Mitsubishi Chemical Corporation was used in the following examples. The average grain size of the powder was approximately ˜200 nm, and the water content was reported to be 36 ppm. As will be obvious to those of skill, the process is applicable to amorphous silica powders obtained from other sources or prepared by other methods, such as by vapor deposition or oxidation of silicon.

### Example 1

### Preparation and Characterization of Crystalline Silica Powders

A small quantity (˜10 g) of amorphous silica powder was placed into a platinum crucible (4.5 cm, diameter; 4.5 cm, height) with a platinum cover and was heated to 1400° C. for 48 hours in a box furnace made by CM Inc. This procedure produced crystallized silica, which was then mixed with fresh amorphous silica powder to make a mixture constituting approximately 15 wt. % crystallized powder. The silica powder mixture was placed into a silica crucible (4.5 cm diameter, 5 cm height) and covered with a silica plate to avoid contamination from the furnace. The powders were heat-treated in a box furnace at 1350° C. in air for 24 h, air-quenched, and crushed with a silica rod to break up the weakly sintered particles. The heat-treated powder surface was cristobalite and slightly opaque. The powders were reheat-treated for an additional 24 h at 1350° C. and air-quenched. To complete the crystallization, the powders were heated at 1400° C. in air for 24 h and air-quenched. This last heat-treatment step at 1400° C. for 24 h was repeated twice more. Thus, the total sequence of the heat-treatment of the powder in this example was: 1350° C., 24 h; 1350° C., 24 h; 1400° C., 24 h; 1400° C., 24 h; and 1400° C., 24 h.

### X-Ray Diffraction

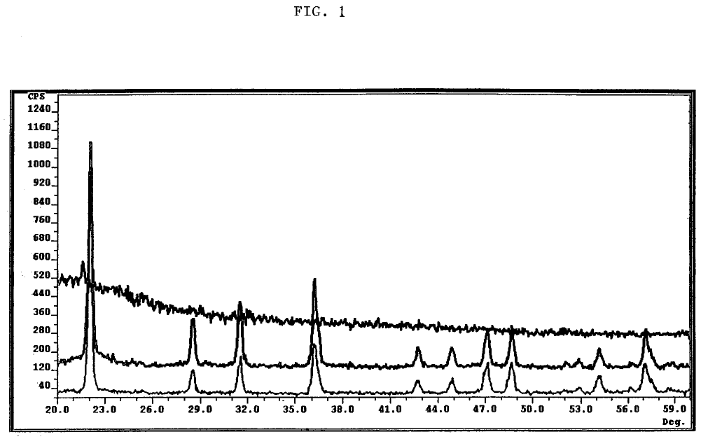

The crystalline phase was analyzed using an X-ray diffractometer. FIG. 1 shows the X-ray diffraction patterns for sol-gel-derived silica powder before and after the crystallization method of Example 1 was performed. The top X-ray diffraction pattern is for the original sol-gel-derived amorphous powder; the bottom, for silica powder heat-treated at 1350° C. for 48 hours; and the middle, for powder heat-treated an additional 48 hours at 1400° C. The three patterns are vertically displaced from each other by 100 units. As indicated by the patterns, the original sol-gel powder was amorphous (top line), and the samples treated by the process of the present invention were cristobalite (middle and bottom).

### Water Content in Powders

The hydroxyl content in the crystalline powder of Example 1 was determined by measuring infrared (IR) absorbance of the powder immersed in a reagent-grade, index matching liquid, CCl₄. A weighted amount of the powder was placed, together with CCl₄, in a sample holder made of fused silica and IR absorbance was measured. The cell length of the sample holder was 1 mm, and the absorbance of the sample holder was below the detection limit. The effective thickness of the sample was calculated from the mass of the sample powders used and the density of silica powders. The water content in the crystalline silica powder was calculated from the absorbance at 3670 cm⁻¹, using the extinction coefficient of 77.51 (of glass)/mol (OH)-cm, as reported by K. M. Davis et al., Non-Cryst. Solids 185, 203 (1995), and the effective thickness of the sample.

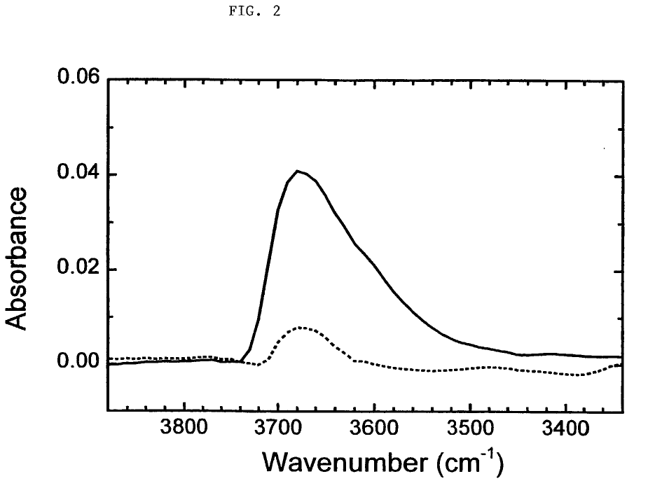

FIG. 2 shows the IR absorbances of the powders in the range of the hydroxyl band. The solid line is the absorbance of sol-gel-derived amorphous powder with an effective thickness of 0.67 mm. The dotted line is the absorbance of powder crystallized by the present process, having an effective thickness of 0.67 mm. The as-received amorphous powders contained 52 ppm of hydroxyl (OH⁻) while the crystalline powders contained 12 ppm of hydroxyl (OH⁻).

The low water content of the powder heat-treated using the present process is due to crystallization rather than to a simple heating of the powder. The equilibrium water content in amorphous silica at 1300-1400° C. is approximately 150 ppm water when heat-treated in air with the water vapor pressure of 10 torr. Without being bound to any theory, one would think that if the powder remained amorphous after the process of the present invention, the water content in the powder would increase from the initial value of 52 ppm, toward the equilibrium value. However, the observed water content of 12 ppm in the powder heat-treated under conditions of the present process, is clearly lower than the equilibrium value, which further indicates the crystalline nature of the powder.

### Example 2

### Melting and Characterization of High Purity Low Water Content Silica Glass

Amorphous silica powder and silica powder crystallized according to the present process, were separately melted in silica crucibles under vacuum (<10⁻⁴ torr) at approximately 1800° C. for 60 min, then cooled to form high purity silica glass. The glass samples were cut into approximately 4.5 mm thick pieces and polished and their IR spectra were obtained. The water content was again determined from the absorption coefficient at 3670 cm⁻¹ using the extinction coefficient of 77.51 (of glass)/mol (OH)-cm.

### Water Content of Silica Glasses

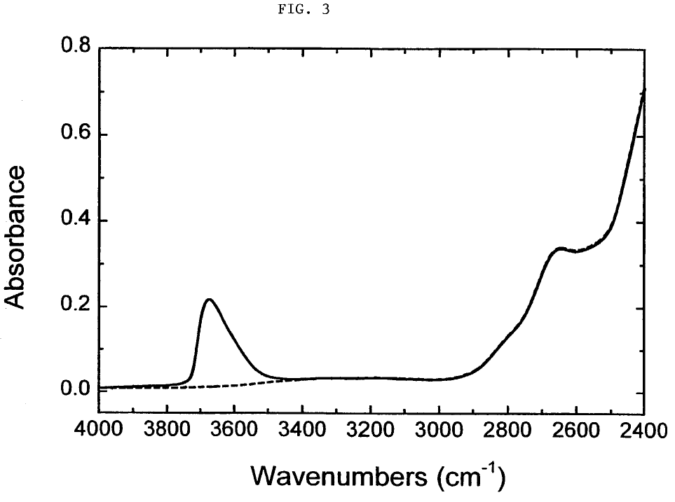

FIG. 3 shows the IR spectra of the SiO₂ glass samples from Example 2, each with an approximate thickness of 4.5 mm. The solid line represents the IR absorbance for SiO₂ glass melted using sol-gel-derived amorphous powder. The dotted line represents the IR absorbance for SiO₂ glass melted using crystallized powder prepared by the process of the present invention (from sol-gel-derived amorphous powder). Water content in the glass in terms of hydroxyl was 44 ppm for the sample made from the amorphous sol-gel-derived powder while it was less than the detection limit for the sample prepared from the crystallized powder of the present method. A thicker specimen approximately 43 mm thick was then cut from the glass derived from the crystallized powder and its IR spectrum was obtained to determine the water content. The water content was less than 0.1 ppm. These results clearly show that the glass sample prepared from crystalline powder has a much lower hydroxyl content than the glass sample prepared from amorphous powder.

We claim:

1. A process for the preparation of a crystalline silica powder comprising:
(a) providing an amorphous silica powder;
(b) heating said amorphous silica powder in the presence of a noble metal at a temperature ranging from about 1300° C. to about 1700° C. for a time sufficient to form said crystalline silica powder.

2. The process of claim 1, wherein said noble metal is platinum or gold.

3. The process of claim 2, wherein said noble metal is platinum.

4. The process of claim 1, wherein said amorphous silica powder is sol-gel-derived amorphous silica powder.

5. The process of claim 1, wherein said temperature ranges from about 1350° C. to about 1400° C.

6. A process for the preparation of a crystalline silica powder comprising:
(a) providing a first portion of an amorphous silica powder;
(b) heating said first portion of said amorphous silica powder in the presence of a noble metal at a temperature ranging from about 1300° C. to about 1700° C. for a time sufficient to form a crystallized powder;
(c) mixing said crystallized powder with a second portion of said amorphous silica powder to form a mixture;
(d) heating said mixture at a temperature ranging from about 1300° C. to about 1700° C. for a time sufficient to form said crystalline silica powder.

7. The process of claim 6, wherein said mixture contains from about 5 wt. % to about 25 wt. % of said crystallized powder.

8. The process of claim 6, wherein said noble metal is platinum or gold.

9. The process of claim 8, wherein said noble metal is platinum.

10. The process of claim 6, wherein said amorphous silica powder is sol-gel-derived amorphous silica powder.

11. The process of claim 6, wherein said temperature ranges from about 1350° C. to about 1400° C.

12. The process of claim 6, further comprising after step (e) the step of reheating said crystalline silica powder at least one time at a temperature ranging from about 1300° C. to about 1700° C. for a time sufficient to crystallize any amorphous silica powder remaining mixed with said crystalline silica powder after heating said mixture.

13. A process for preparing silica glass, said process comprising:
(a) providing a crystalline silica powder prepared by crystallizing amorphous silica powder in the presence of a noble metal;
(b) melting said crystalline silica powder to form a molten glass; and
(c) cooling said molten glass to form said silica glass.

14. The process of claim 13, wherein said noble metal is platinum or gold.

15. The process of claim 14, wherein said noble metal is platinum.

16. The process of claim 13, wherein said silica glass has a water content of less than 0.1 ppm.

17. The process of claim 16, wherein said amorphous silica powder is sol-gel-derived amorphous silica powder.

18. The process of claim 17, wherein said silica glass is high purity silica glass.

19. The process of claim 13, wherein said temperature ranges from about 1350° C. to about 1400° C.

20. A high purity silica glass having a water content of less than 0.1 ppm.
